(19) United States
(12) Patent Application Publication
(10) Pub. No.: US 2026/0339351 A1
(43) Pub. Date: Oct. 29, 2026

(54) ROBOT

(71) Applicant: SHENZHEN HANYANG TECHNOLOGY CO., LTD., Shenzhen (CN)

(72) Inventors: Taotao ZHU, Shenzhen (CN); Yongqi SONG, Shenzhen (CN); Haitao LI, Shenzhen (CN)

(21) Appl. No.: 19/704,188

(22) Filed: Jun. 10, 2026

Related U.S. Application Data
(63) Continuation of application No. PCT/CN2023/139516, filed on Dec. 18, 2023.

(30) Foreign Application Priority Data
Jun. 16, 2023 (CN) 202310724634.0
Jun. 16, 2023 (CN) 202321560825.X
Jun. 19, 2023 (CN) 202310731574.5
Jun. 19, 2023 (CN) 202321576749.1

(51) Int. Cl. G05D 1/672; E01H 5/09; G05D 105/00; G05D 105/10; G05D 105/15

(52) U.S. Cl. CPC G05D 1/672; E01H 5/098; G05D 2105/10; G05D 2105/12; G05D 2105/15

(57) ABSTRACT

A robot. The robot includes a head and a body, and the head is detachably connected to the body.

### CROSS REFERENCE TO RELATED APPLICATIONS

The present application is a continuation of and claims priority to and benefits of PCT Application No. PCT/CN2023/139516 filed on Dec. 18, 2023, which further claims the priority and benefits of Chinese Application Nos. 202310724634.0 and 202321560825.X, both filed on Jun. 16, 2023, and Chinese Application Nos. 202310731574.5 and 202321576749.1, both filed on Jun. 19, 2023. The contents of each of the above-referenced patent applications are hereby incorporated by reference as part of the disclosure of the document.

### TECHNICAL FIELD

The present application relates to the field of artificial intelligence, and more particularly to a robot.

### BACKGROUND

A robot includes a head and a body. The robot needs to use different heads for different operating scenarios. However, the head is fixed to the body and cannot be installed or removed, which cannot meet the diverse operational needs of a user.

### SUMMARY

In view of these, an objective of embodiments of the present disclosure is to overcome deficiencies in the prior art and provide a robot.

Some embodiments of the present disclosure provide a robot. The robot includes a head and a body, and the head is detachably connected to the body.

Some embodiments of the present disclosure provide a multifunctional robot. The multifunctional robot is the robot provided in the above embodiments. The multifunctional robot includes a functional unit and a travel unit. The functional unit is at least a part of the head, and the functional unit is configured to perform functions including but not limited to the following: snow clearing, and/or weed removal, and/or seeding, and/or surface cleaning. The travel unit is at least a part of the body and is configured to travel independently of the functional unit under control of a user and/or a computer program. The travel unit has a first connection portion, the first connection portion is at least a part of a first connecting component, the functional unit has a second connection portion, the second connection portion is at least a part of a second connecting component, the travel unit and the functional unit are manually connectable and disconnectable through the first connection portion and the second connection portion, and the manual detachable connection simultaneously satisfies all of the following conditions: the user does not need to use an additional tool and is able to complete the manual detachable connection using only their own limbs; the manual detachable connection is completable without operating the travel unit or changing an orientation of the travel unit; during the manual detachable connection, the functional unit only needs to move relative to the travel unit in a single direction; and no mechanical transmission exists between the functional unit and the travel unit during and/or after the manual detachable connection.

Some embodiments of the present disclosure have the following advantages: the head and the body of the robot proposed in the present disclosure are detachably connected, thereby enabling the head and the body to be assembled and disassembled. The user can replace different heads according to operating scenarios, thereby meeting the diverse operational needs of the user.

To make the above objectives, features, and advantages of the embodiments of the present disclosure more apparent and understandable, some embodiments are described in detail below with reference to the accompanying drawings.

### BRIEF DESCRIPTION OF THE DRAWINGS

To illustrate the technical solutions of embodiments of the present disclosure more clearly, the accompanying drawings for illustrating some embodiments are briefly described below. It should be understood that the accompanying drawings below only show some embodiments of the present disclosure, and thus should not be regarded as a limitation on the scope. A person of ordinary skill in the art may derive other related drawings from these drawings without undue effort.

FIG. 1 shows a schematic diagram of a head; FIG. 2 shows a schematic diagram of a body; FIG. 2a shows a partial enlarged view of position A in FIG. 2; FIG. 3 shows a schematic diagram of a backplate; FIG. 3a shows a partial enlarged view of position B in FIG. 3; FIG. 4 shows a schematic diagram of a connection between a first connecting component and a second connecting component in Embodiment 1; FIG. 5 shows a schematic diagram of a first connecting component in Embodiment 2; FIG. 6 shows a schematic diagram of a second connecting component in Embodiment 2; FIG. 7 is a schematic structural diagram of a robot according to some embodiments of the present disclosure; FIG. 8 is a first schematic structural diagram of a head of the robot in FIG. 7; FIG. 9 is a second schematic structural diagram of a head of the robot in FIG. 7; FIG. 10 is a first schematic structural diagram of a locking-hook assembly of the robot in FIG. 7; FIG. 11 is a third schematic structural diagram of a head of the robot in FIG. 7; FIG. 12 is a partial enlarged view of region C in FIG. 11; FIG. 13 is a second schematic structural diagram of a locking-hook assembly of the robot in FIG. 7; FIG. 14 is a schematic structural diagram of a locking hook of the robot in FIG. 7; FIG. 15 is a schematic structural diagram of a pivot member of the robot in FIG. 7; FIG. 16 is a third schematic structural diagram of a locking-hook assembly of the robot in FIG. 7; FIG. 17 is a fourth schematic structural diagram of a head of the robot in FIG. 7; FIG. 18 is a fourth schematic structural diagram of a locking-hook assembly of the robot in FIG. 7; FIG. 19 is a first schematic structural diagram of an execution unit of the robot in FIG. 7; FIG. 20 is a partial enlarged view of region D in FIG. 19; FIG. 21 is a second schematic structural diagram of an execution unit of the robot in FIG. 7; FIG. 22 is a partial enlarged view of region E in FIG. 21; FIG. 23 is a third schematic structural diagram of an execution unit of the robot in FIG. 7; FIG. 24 is a partial enlarged view of region F in FIG. 23; FIG. 25 is a fourth schematic structural diagram of an execution unit of the robot in FIG. 7; FIG. 26 is a partial enlarged view of region G in FIG. 25; FIG. 27 is a fifth schematic structural diagram of an execution unit of the robot in FIG. 7; FIG. 28 is a partial enlarged view of region H in FIG. 27; FIG. 29 is a schematic structural diagram of an actuator of the execution unit of the robot in FIG. 7; FIG. 30 shows a schematic diagram of a functional unit and a travel unit of a multifunctional robot in a disassembled state; FIG. 31 shows a schematic diagram of a functional unit; FIG. 32 shows a schematic diagram of a travel unit; FIG. 33 shows a first schematic diagram of a position adjustment device of the multifunctional robot in FIG. 30; FIG. 34 shows a second schematic diagram of a position adjustment device of the multifunctional robot in FIG. 30; FIG. 34a shows a partial enlarged view of region I in FIG. 34; FIG. 34b shows a partial enlarged view of region J in FIG. 34; FIG. 35 shows a third schematic diagram of a position adjustment device of the multifunctional robot in FIG. 30; FIG. 36 shows a schematic diagram of an assembly component; FIG. 36a shows a partial enlarged view of region K in FIG. 36; FIG. 37 shows a schematic diagram of a position adjustment device of the multifunctional robot in FIG. 30 according to some embodiments; and FIG. 38 shows a schematic diagram of a position adjustment device of the multifunctional robot in FIG. 30 according to some embodiments.

### DETAILED DESCRIPTION

To enable those skilled in the art to better understand the technical solutions of the present disclosure, the technical solutions in the embodiments of the present disclosure will be clearly and completely described below with reference to the accompanying drawings. Apparently, the described embodiments are only a part of the embodiments of the present disclosure, rather than all of the embodiments. Based on the embodiments of the present disclosure, all other embodiments obtained by those skilled in the art without undue effort fall within the scope of the present disclosure.

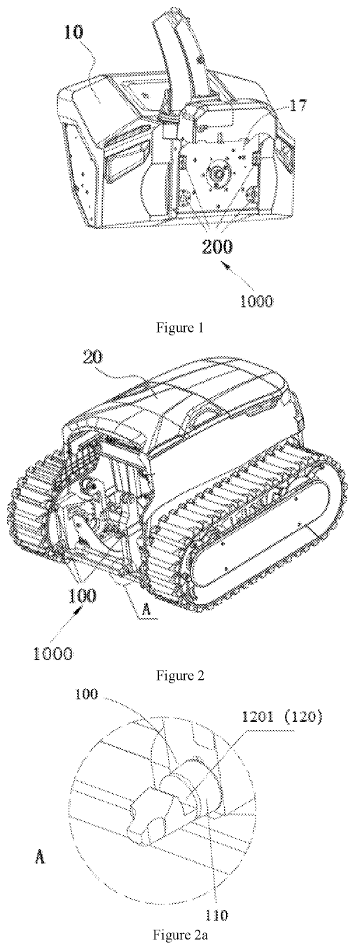

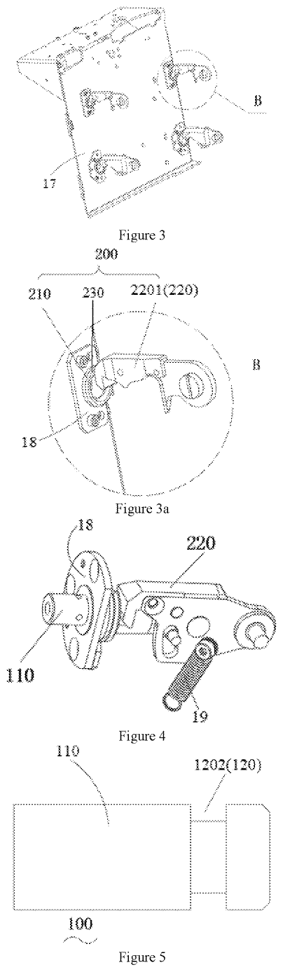

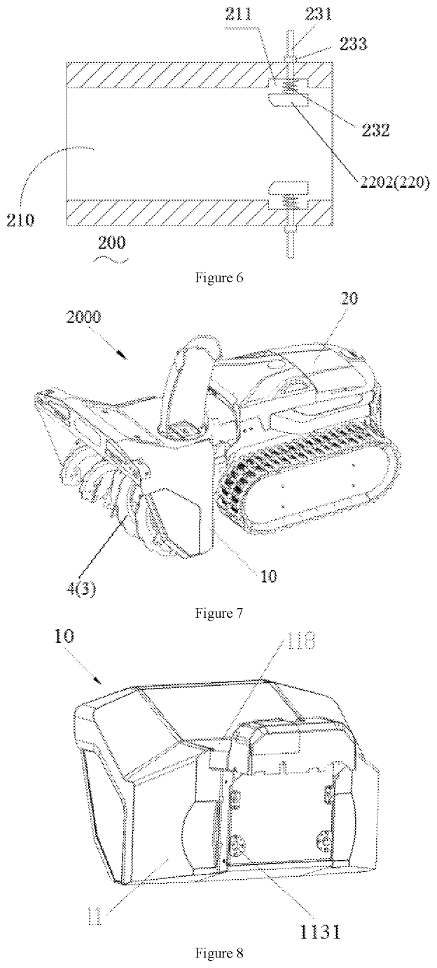

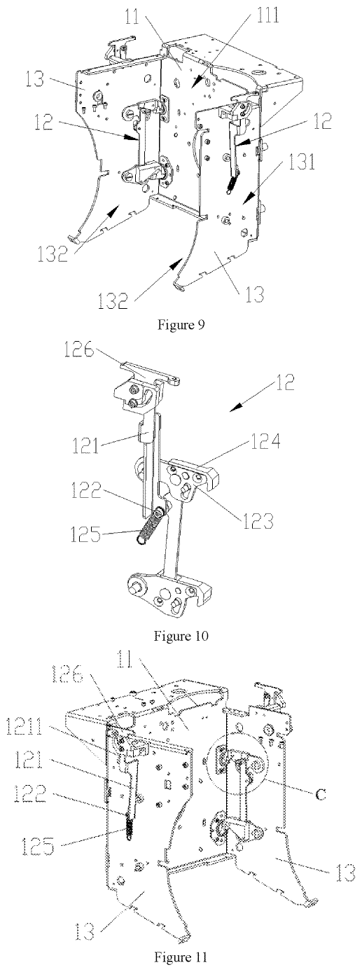

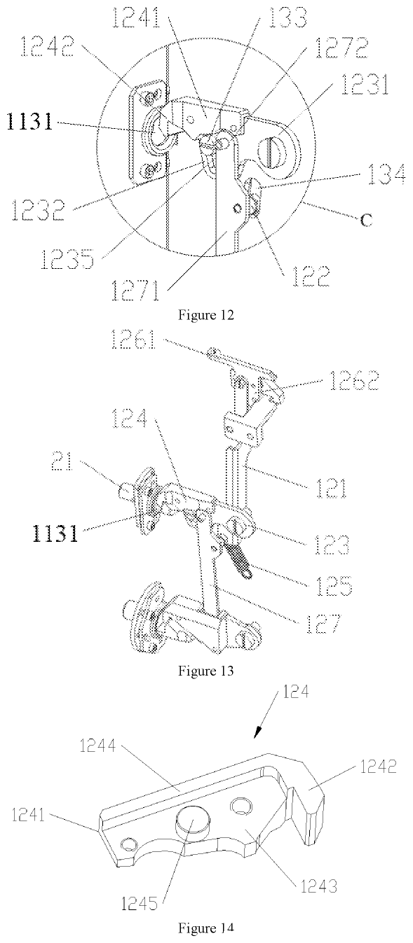

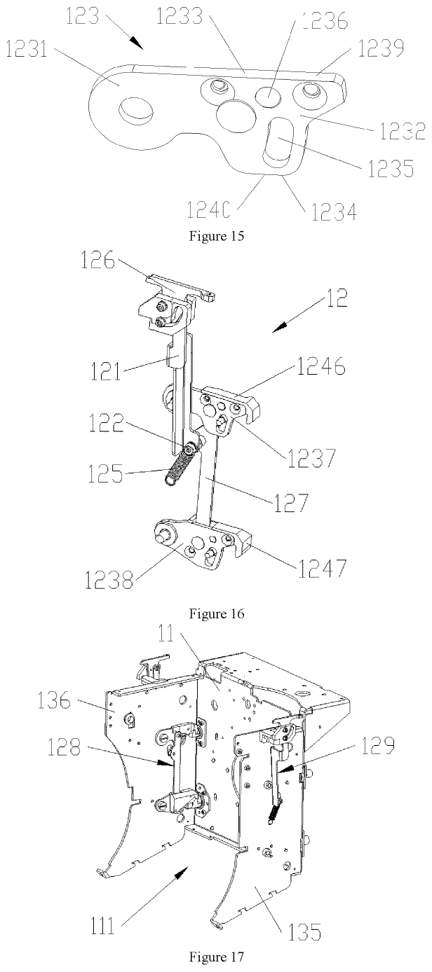

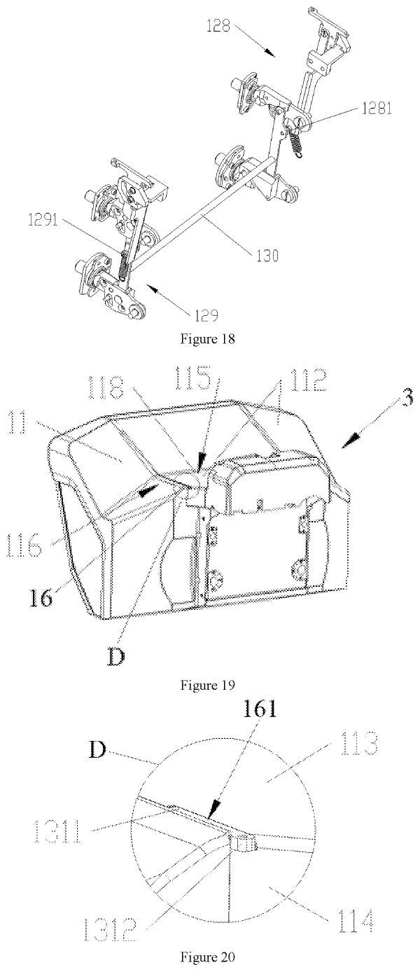

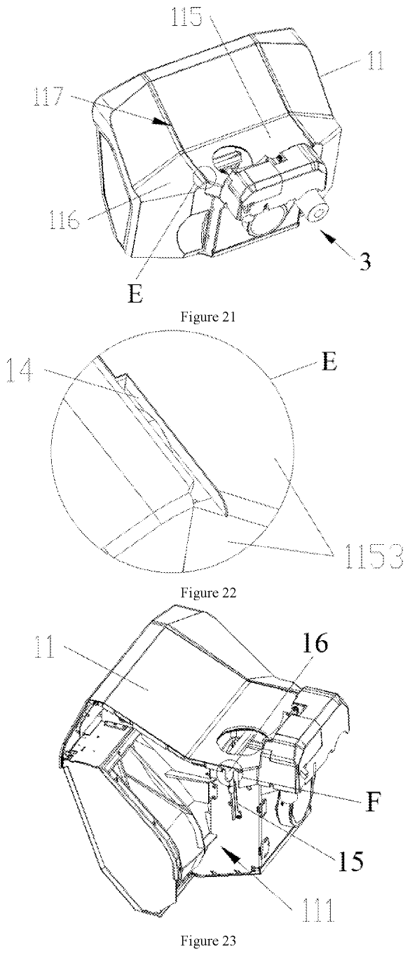

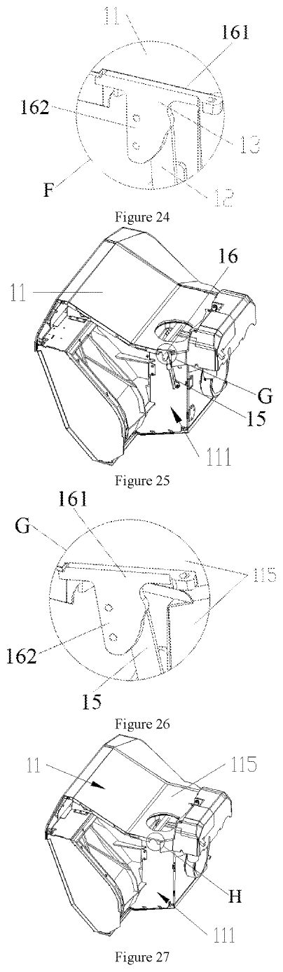

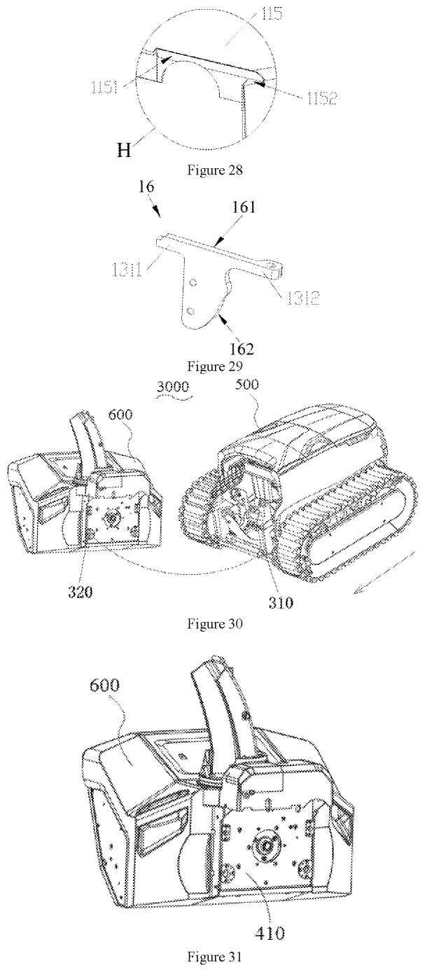

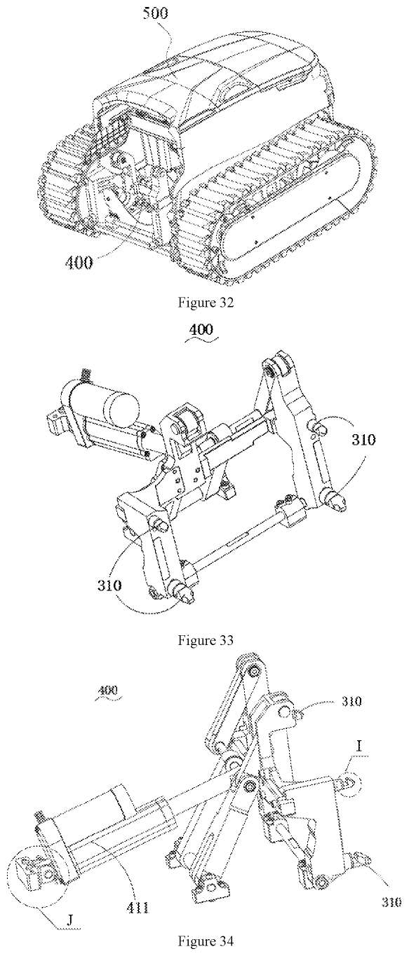

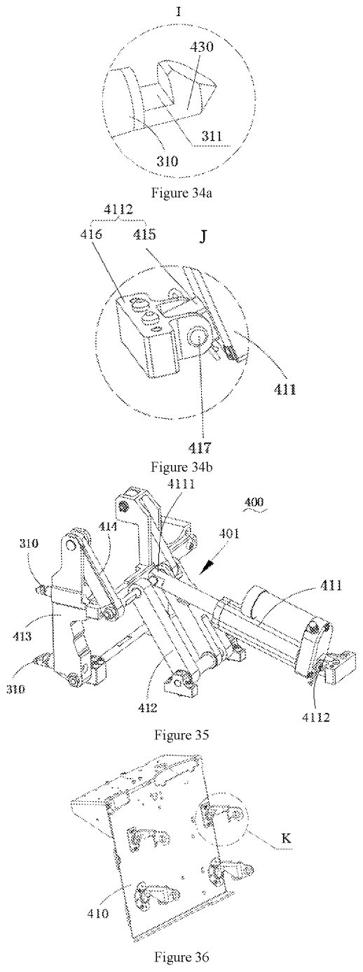

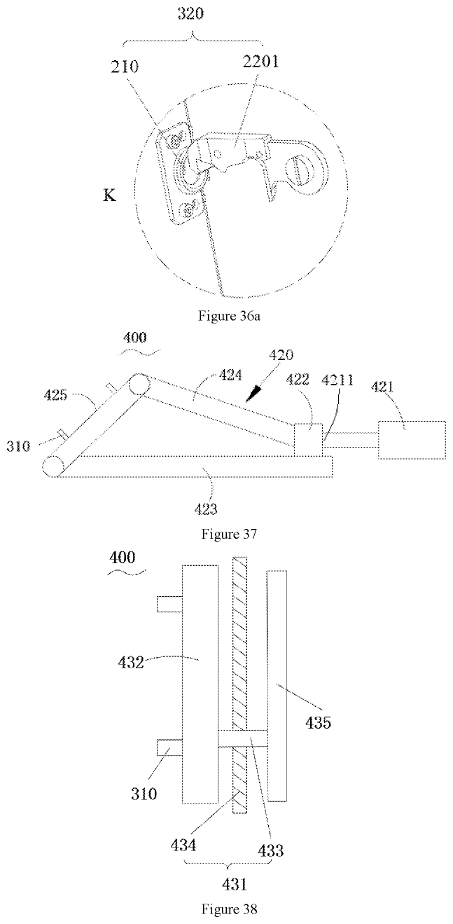

Referring to FIG. 1, FIG. 2, and FIG. 7, some embodiments of the present disclosure provide a robot 2000. The robot 2000 includes a head 10 and a body 20, and the head 10 is detachably connected to the body 20. In this way, the detachable connection between the head 10 and the body 20 enables the head 10 and the body 20 to be assembled and disassembled. A user may replace different heads 10 according to operating scenarios, thereby meeting the diverse operational needs of the user.

Referring to FIG. 1 and FIG. 2, in some embodiments, the robot 2000 includes a connection structure 1000 for the robot 2000, and the head 10 and the body 20 are detachably connected through the connection structure 1000. The connection structure 1000 includes a first connecting component 100 and a second connecting component 200. Through the engagement of the first connecting component 100 and the second connecting component 200, a connection between two components on the robot 2000 may be achieved. The head 10 and the body 20 of the robot 2000 are used herein as an illustrative example.

Of the first connecting component 100 and the second connecting component 200, one is disposed on the head 10 of the robot 2000 and the other is disposed on the body 20 of the robot 2000. The first connecting component 100 is configured to be inserted into the second connecting component 200 to enable a detachable connection between the first connecting component 100 and the second connecting component 200.

When the head 10 and the body 20 are assembled, the first connecting component 100 is inserted into the second connecting component 200 to achieve the connection between the first connecting component 100 and the second connecting component 200, thus completing the assembly of the head 10 and the body 20. The connection structure 1000 is easy to operate and can complete the assembly of the head 10 and the body 20 without the need for tools. The connection structure 1000 not only reduces assembly difficulty but also improves assembly efficiency.

The first connecting component 100 and the second connecting component 200 may be configured as needed: the first connecting component 100 is disposed on the head 10 and the second connecting component 200 is disposed on the body 20; or the first connecting component 100 is disposed on the body 20 and the second connecting component 200 is disposed on the head 10.

For ease of illustration, the following description takes as an example the configuration in which the first connecting component 100 is disposed on the body 20 and the second connecting component 200 is disposed on the head 10. As shown in FIG. 2 and FIG. 2a, the first connecting component 100 includes an insertion rod 110, and a first engaging portion 120 is disposed on the insertion rod 110.

As shown in FIG. 1 and FIG. 3, the head 10 includes a backplate 17, and the second connecting component 200 includes a guide portion 230 having an insertion hole 210 and a second engaging portion 220. That is, the second connecting component 200 includes the guide portion 230 and the second engaging portion 220, the guide portion 230 has the insertion hole 210, and the insertion hole 210 may be disposed on the backplate 17. The insertion rod 110 is configured to pass through the insertion hole 210 to connect the second engaging portion 220 with the first engaging portion 120.

As shown in FIG. 3a, a mounting seat 18 may be disposed on the backplate 17, and the insertion hole 210 passes through the mounting seat 18.

In some embodiments, the first engaging portion 120 is a latch slot 1201 disposed on the insertion rod 110, and the second engaging portion 220 is a rotatable latch 2201 configured to engage the latch slot 1201. The latch 2201 may be rotatably connected to the head 10 through a structure such as a rotating shaft.

As shown in FIG. 3a, the latch 2201 is disposed adjacent to the outlet end of the insertion hole 210. The insertion hole 210 has an inlet end and an outlet end located at opposite ends thereof. The insertion rod 110 enters the insertion hole 210 through the inlet end and extends out of the insertion hole 210 through the outlet end, such that the insertion rod 110 passes through the insertion hole 210.

To enable the latch slot 1201 on the insertion rod 110 to engage the latch 2201, a length of the insertion rod 110 must be greater than a depth of the insertion hole 210.

Referring to FIG. 4, a connection between the first connecting component 100 and the second connecting component 200 may be made according to the following process:

The insertion rod 110 is aligned with the insertion hole 210; by moving the first connecting component 100 or the second connecting component 200, the insertion rod 110 is inserted into the insertion hole 210 through the inlet end of the insertion hole 210; the insertion rod 110 is driven to move toward the outlet end of the insertion hole 210, and the latch slot 1201 on the insertion rod 110 extends beyond the insertion hole 210; and the latch 2201 engages the latch slot 1201, thereby achieving the connection between the first connecting component 100 and the second connecting component 200.

Since the first connecting component 100 is disposed on the body 20 and the second connecting component 200 is disposed on the head 10, after the first connecting component 100 is connected to the second connecting component 200, the assembly of the body 20 and the head 10 is also completed.

Referring to FIG. 4, the latch 2201 is rotatably disposed on the head 10 and may be connected to a tension spring 19. After the latch 2201 engages the latch slot 1201, an elastic force provided by the tension spring 19 maintains the latch 2201 and the latch slot 1201 in latching engagement. To disengage the latch 2201 from the latch slot 1201, an external force may drive the latch 2201 to rotate, so that the latch 2201 separates from the latch slot 1201. The insertion rod 110 is then moved out of the insertion hole 210 to achieve separation of the head 10 from the body 20. The latch 2201 may be connected to components such as a push rod, and an external force applied to the push rod drives the latch 2201 to rotate.

To ensure stability and reliability of the assembly of the head 10 and the body 20, a plurality of first connecting components 100 and a corresponding plurality of second connecting components 200 are provided, each first connecting component 100 corresponding to one second connecting component 200. The numbers of the first connecting components 100 and the second connecting components 200 may be set as needed—for example, four or five first connecting components 100 and four or five second connecting components 200 may be provided.

Referring to FIG. 1 and FIG. 3, to ensure reliability of the connection, the first connecting components 100 are distributed in a rectangular array, and the second connecting components 200 are distributed in the same array pattern as the first connecting components 100. In some embodiments, the first connecting components 100 may be distributed in a circular array, and correspondingly, the second connecting components 200 are also distributed in a circular array.

As shown in FIG. 5, in some embodiments, the first engaging portion 120 is a groove 1202 disposed on the insertion rod 110, and the groove 1202 may be disposed near a tip of the insertion rod 110. The insertion rod 110 is configured to be inserted into the insertion hole 210 to connect the second engaging portion 220 with the first engaging portion 120.

As shown in FIG. 6, in some embodiments, the second engaging portion 220 is a slidable protrusion 2202 configured to be received within the groove 1202. The groove 1202 extends circumferentially around the insertion rod 110, thereby facilitating a connection between the protrusion 2202 and the groove 1202.

The protrusion 2202 is disposed within the insertion hole 210 and is slidably connected to a wall of the insertion hole 210. A pull rod 231 is disposed on the protrusion 2202 and passes through the wall of the insertion hole 210, the pull rod 231 being slidably connected to the wall. An accommodating groove 211 for receiving the protrusion 2202 is defined in an inner wall of the insertion hole 210. The protrusion 2202 may be moved into the accommodating groove 211 by pulling the pull rod 231. A spring 232 is fitted around the pull rod 231, and opposite ends of the spring 232 abut against the protrusion 2202 and an end surface of the accommodating groove 211 respectively, thereby causing the protrusion 2202 to protrude beyond the accommodating groove 211.

A sleeve ring 233 is fitted around the pull rod 231. The sleeve ring 233 retains the pull rod 231 to prevent the pull rod 231 from detaching from the wall of the insertion hole 210, while ensuring that the opposite ends of the spring 232 remain in contact with their respective abutment surfaces. The sleeve ring 233 may be threadedly connected to the pull rod 231.

Referring to FIG. 5 and FIG. 6, a connection between the first connecting component 100 and the second connecting component 200 may be made according to the following process:

The tip of the insertion rod 110 is aligned with the insertion hole 210; by moving the first connecting component 100 or the second connecting component 200, the insertion rod 110 is inserted into the insertion hole 210 through the inlet end of the insertion hole 210; after the tip of the insertion rod 110 makes contact with the protrusion 2202, the insertion rod 110 continues to be driven toward the outlet end of the insertion hole 210; as the insertion rod 110 moves, the tip of the insertion rod 110 pushes against the protrusion 2202, causing the protrusion 2202 to move into the accommodating groove 211; and the insertion rod 110 continues to move, and when the groove 1202 is aligned with the protrusion 2202, the protrusion 2202 is received within the groove 1202 under the force of the spring 232, thereby achieving the connection between the first connecting component 100 and the second connecting component 200.

Since the first connecting component 100 is disposed on the body 20 and the second connecting component 200 is disposed on the head 10, after the first connecting component 100 is connected to the second connecting component 200, the assembly of the body 20 and the head 10 is also completed.

Referring to FIG. 6, the protrusion 2202 is slidably connected to the wall of the insertion hole 210. After the protrusion 2202 is received within the groove 1202, the elastic force provided by the spring 232 maintains the protrusion 2202 in the received state. To disengage the protrusion 2202 from the groove 1202, the pull rod 231 may be pulled by an external force to cause the protrusion 2202 to move into the accommodating groove 211, thereby achieving separation of the protrusion 2202 from the groove 1202. The insertion rod 110 is then moved out of the insertion hole 210 to achieve separation of the head 10 from the body 20.

According to existing technology, the robot 2000 uses different heads 10 for different operating scenarios. However, the connection structure between the head 10 and the body 20 is complex and professionals use specialized tools for assembly and disassembly, which is time-consuming and does not allow for quick installation and removal, and cannot meet the diverse operational needs of users.

As shown in FIG. 7 to FIG. 18, the head 10 is detachably connected to the body 20 through a locking-hook assembly 12. With this arrangement, the head 10 and the body 20 can be quickly locked and unlocked through the locking-hook assembly 12, achieving quick assembly and disassembly of the head 10 and the body 20. The user may quickly replace different heads 10 according to operating scenarios, thereby meeting the diverse operational needs of the user.

In some embodiments, as shown in FIG. 7 to FIG. 18, the head 10 and the external device can be quickly locked and unlocked through the locking-hook assembly 12, achieving quick assembly and disassembly of the head 10 and the external device. The user may quickly replace different heads 10 according to operating scenarios, thereby meeting the diverse operational needs of the user. In some embodiments, the external device is the body 20.

As shown in FIG. 8, FIG. 9, and FIG. 10, the head 10 of the present disclosure includes a housing 11 and at least one locking-hook assembly 12 disposed on the housing 11. The locking-hook assembly 12 includes a locking hook 124 rotatably disposed on the housing 11. The locking hook 124 has a locked position in which the locking hook 124 is connected to the external device and an unlocked position in which the locking hook 124 is separated from the external device.

With this arrangement, the head 10 and the external device can be quickly locked and unlocked through the locking-hook assembly 12, achieving quick assembly and disassembly of the head 10 and the external device. The user may quickly replace different heads 10 according to operating scenarios, thereby meeting the diverse operational needs of the user.

As shown in FIG. 8, FIG. 9, and FIG. 10, in some embodiments, the locking-hook assembly 12 further includes a transmission member 121 movably disposed on the housing 11. The transmission member 121 is drivingly connected to the locking hook 124 through a link member 122 so as to drive the locking hook 124 to rotate under an external force. The locking-hook assembly 12 with this arrangement has a simple structure and low production cost.

In some embodiments, the housing 11 defines an interior cavity 111 and includes a partition 13. The transmission member 121 is disposed on an outer side 131 of the partition 13, the locking hook 124 is disposed on an inner side 132 of the partition 13 (i.e., the locking hook 124 is disposed within the interior cavity 111), and the link member 122 is movably disposed on the partition 13.

In some embodiments, as shown in FIG. 7 to FIG. 18, a connection portion 21 is disposed on the body 20, the connection portion 21 is at least a part of the insertion rod 110, and the connection portion 21 enters the interior cavity 111 and is connected to the locking hook 124. This arrangement causes the connection structure between the body 20 and the head 10 to be located within the interior cavity 111, preventing the connection structure between the body 20 and the head 10 from being affected by external factors, and improving the stability of the connection between the body 20 and the head 10.

In the embodiments of the present disclosure, the locking-hook assemblies 12 are disposed on opposite sides of the partition 13, thereby preventing mutual interference between the locking-hook assemblies 12 and other components located within the interior cavity 111, ensuring that the locking-hook assemblies 12 are in a stable operating state, improving the stability of the connection between the head 10 and the external device, and overcoming the deficiency found in some robots 2000 of poor stability in the connection structure between the head 10 and the body 20 and frequent locking or unlocking failures.

In the embodiments of the present disclosure, the transmission member 121 and the link member 122 drive the locking hook 124 to rotate, completing the process of unlocking the external device. With this arrangement, the number of parts for driving the locking hook 124 to rotate is small, the structure is simple, the production cost is low, and the connection stability between each part is high. In some embodiments, the link member 122 is a rotating shaft.

As shown in FIG. 11 and FIG. 12, in some embodiments, a travel slot 134 is defined in the partition 13 and extends through the partition 13. The link member 122 is disposed within the travel slot 134 and moves within the travel slot 134 under the driving of the transmission member 121. This arrangement limits the movement range of the link member 122, thereby limiting the rotation range of the transmission member 121 and preventing an excessive rotation angle of the locking hook 124 caused by an excessive rotation angle of the transmission member 121. In some embodiments, the travel slot 134 is arc-shaped.

As shown in FIG. 8, FIG. 10, FIG. 11, and FIG. 13, in some embodiments, an upper end 1211 of the transmission member is disposed adjacent to a top portion 118 of the housing. This arrangement enables the user to more easily apply an external force to the transmission member 121.

In some embodiments, the locking-hook assembly 12 further includes a toggle member 126. The toggle member 126 has an operating end 1261 and a connecting end 1262. The operating end 1261 is exposed from the housing 11, and the connecting end 1262 is drivingly connected to the upper end 1211 of the transmission member. The toggle member 126 is configured to drive the transmission member 121 to move under an external force so as to drive the locking hook 124 to rotate. This arrangement enables the user to more easily operate the locking hook 124 and improves the user experience.

As shown in FIG. 10, in some embodiments, the locking-hook assembly 12 further includes an elastic member 125. One end of the elastic member 125 is disposed on the partition 13 and the other end is connected to the link member 122 or the transmission member 121. The elastic member 125 is configured to bias the locking hook 124 toward the locked position. When the transmission member 121 drives the link member 122 and the locking hook 124 to rotate under an external force, the elastic member 125 deforms. When the external force is removed, the elastic member 125 returns to its original state and drives the transmission member 121, the link member 122, the pivot member 123, and the locking hook 124 back to the locked position. This arrangement provides the locking hook 124 with a spring-return function, so that the locking hook 124 is in the locked position when no external force is applied.

In some embodiments, an end of the elastic member 125 is wound around the outer circumference of the link member 122. In some embodiments, the elastic member 125 is a spring.

As shown in FIG. 14 and FIG. 15, in some embodiments, the link member 122 is drivingly connected to the locking hook 124 through a pivot member 123. The locking hook 124 includes a locking-hook body 1241 and a hook portion 1242 connected to each other. The locking-hook body 1241 has a first sidewall 1243 and a second sidewall 1244 connected to each other. The first sidewall 1243 is connected to the pivot member 123, and the second sidewall 1244 is in contact with a top surface 1239 of the pivot member or a bottom surface 1240 of the pivot member.

A surface of the pivot member 123 facing away from the ground is the top surface 1239 of the pivot member, and a surface of the pivot member 123 facing toward the ground is the bottom surface 1240 of the pivot member. This arrangement increases the contact area between the pivot member 123 and the locking hook 124, improves the stability of the connection between the pivot member 123 and the locking hook 124, and thus increases the stability of the locking-hook assembly 12.

In some embodiments, the second sidewall 1244 is in contact with the top surface 1239 of the pivot member, and an opening of the hook portion 1242 faces away from the ground. The transmission member 121 rotates in a direction away from the ground under an external force and drives the link member 122, the pivot member 123, and the locking hook 124 to rotate.

In some embodiments, the second sidewall 1244 is in contact with the bottom surface 1240 of the pivot member, and the opening of the hook portion 1242 faces toward the ground. The transmission member 121 rotates in a direction toward the ground under an external force and drives the link member 122, the pivot member 123, and the locking hook 124 to rotate.

As shown in FIG. 14 and FIG. 15, in some embodiments, one of the first sidewall 1243 and the pivot member 123 includes a connecting post 1245, the other of the first sidewall 1243 and the pivot member 123 defines a connecting hole 1236, and the connecting post 1245 is received within the connecting hole 1236. This arrangement connects the pivot member 123 and the locking hook 124 through the connecting post 1245 and the connecting hole 1236, improving the stability of the connection between the pivot member 123 and the locking hook 124.

In some embodiments, a connecting post 1245 is disposed on the first sidewall 1243 and is formed integrally with the first sidewall 1243.

As shown in FIG. 10, FIG. 14, and FIG. 15, in some embodiments, the pivot member 123 has a fixed end 1231 and a free end 1232. The fixed end 1231 is disposed on the partition 13, the free end 1232 is rotatable relative to the fixed end 1231, the free end 1232 is connected to the link member 122, the first sidewall 1243 is connected to the free end 1232, and the second sidewall 1244 is in contact with a top surface 1233 of the free end or a bottom surface 1234 of the free end. Compared to disposing the middle of the pivot member 123 on the partition 13, this arrangement increases the rotation radius of the free end 1232, increases the contact area between the pivot member 123 and the locking hook 124, improves the stability of the connection between the pivot member 123 and the locking hook 124, and thus increases the stability of the locking-hook assembly 12.

As shown in FIG. 11 and FIG. 12, in some embodiments, the locking hook 124 is rotatably mounted on the housing 11. One of the housing 11 and the locking hook 124 defines a limit slot 1235, the limit slot 1235 extends in a rotational direction of the locking hook 124, the other of the housing 11 and the locking hook 124 includes a limit member 133, and the limit member 133 is slidably received in the limit slot 1235 along a length direction of the limit slot 1235. This arrangement limits the rotation angle of the locking hook 124, preventing an excessive rotation angle of the locking hook 124 that would make it difficult to return to the locked position.

In some embodiments, the locking hook 124 is rotatably mounted on the partition 13 through the pivot member 123. One of the partition 13 and the free end 1232 of the pivot member defines a limit slot 1235, and the other of the partition 13 and the free end 1232 of the pivot member includes a limit member 133. The limit member 133 is disposed within the limit slot 1235. Through the engagement of the limit member 133 and the limit slot 1235, the pivot member 123 can only rotate within a preset range, and this arrangement prevents an excessive rotation angle of the locking hook 124 caused by an excessive rotation angle of the pivot member 123.

In some embodiments, the limit slot 1235 is arc-shaped.

As shown in FIG. 16, in some embodiments, the locking-hook assembly 12 further includes a first linkage member 127, and two locking hooks 124 are provided, including a first locking hook 1246 and a second locking hook 1247. The first linkage member 127 is connected to the first locking hook 1246 and the second locking hook 1247 respectively, the transmission member 121 is drivingly connected to the first linkage member 127, and the first linkage member 127 is configured to drive the first locking hook 1246 and the second locking hook 1247 to move synchronously. This arrangement increases the number of locking hooks 124 and improves the stability of the connection between the head 10 and the external device.

In some embodiments, the first locking hook 1246 is configured with a corresponding first pivot member 1237, and the second locking hook 1247 is configured with a corresponding second pivot member 1238. The first linkage member 127 is disposed on the inner side 132 of the partition 13 and includes a first linkage member body 1271 and two first linkage member end portions 1272. The link member 122 is connected to the first linkage member body 1271, and the two first linkage member end portions 1272 are connected to the first pivot member 1237 and the second pivot member 1238 respectively. This arrangement increases the number of locking hooks 124 and improves the stability of the connection between the head 10 and the external device.

As shown in FIG. 12 and FIG. 13, in some embodiments, a communication hole 1131 is defined in the housing 11, the communication hole 1131 is located on a side of the housing 11 facing the external device, the communication hole 1131 is in communication with the interior cavity 111, and the locking hook 124 is disposed within the interior cavity 111 and faces the communication hole 1131. The communication hole 1131 is configured to allow at least a portion of the external device to enter the interior cavity 111 and connect with the locking hook 124, thereby achieving locking between the external device and the head 10. This arrangement allows the locking hook 124 to be located within the housing 11, preventing collision, wear, or oxidation of the locking hook 124 caused by exposure of the locking hook 124, thereby extending the service life of the locking hook 124.

As shown in FIG. 17 and FIG. 18, in some embodiments, at least two partitions 13 are provided, including a first partition 135 and a second partition 136. The first partition 135 and the second partition 136 are disposed side by side, and an interior cavity 111 is defined between the first partition 135 and the second partition 136.

At least one locking-hook assembly 12 includes a first locking-hook assembly 128 and a second locking-hook assembly 129. A link member 1281 of the first locking-hook assembly is disposed on the first partition 135, and a link member 1291 of the second locking-hook assembly is disposed on the second partition 136. The link member 1281 of the first locking-hook assembly and the link member 1291 of the second locking-hook assembly are connected through a second linkage member 130.

This arrangement increases the number of locking hooks 124 and improves the stability of the connection between the head 10 and the external device. Through the second linkage member 130, the first locking-hook assembly 128 and the second locking-hook assembly 129 rotate synchronously. The user applies an external force to a transmission member of the first locking-hook assembly 128 or a transmission member of the second locking-hook assembly 129 to achieve rotation of a locking hook of the first locking-hook assembly 128 and a locking hook of the second locking-hook assembly 129, making operation convenient.

As shown in FIG. 7 and FIG. 19 to FIG. 29, the robot 2000 includes a robot body 2 and an execution unit 3 assembled on the robot body 2. The robot body 2 drives the execution unit 3 to operate within a predetermined area. The robot body 2 is at least a part of the body 20, and the execution unit 3 is at least a part of the head 10.

According to the existing technology, the robot body 2 and the execution unit 3 of the robot 2000 can be quickly disassembled, but a suitable position for mounting an unlocking device to unlock the robot body 2 and the execution unit 3 has not been found, making it inconvenient for the user to operate.

The execution unit 3 of the present disclosure can be applied to the robot 2000. To unlock the robot body 2 and the execution unit 3, an external force is applied to the actuator 16 to quickly unlock the robot body 2 and the execution unit 3. The unlocking process is simple and time-efficient.

As shown in FIG. 7 and FIG. 19 to FIG. 29, in some embodiments, the execution unit 3 includes a working component 4 capable of performing one or more of snow clearing, weed removal, seeding, and surface cleaning. The execution unit 3 further includes a housing 11, an adapter 15, and an actuator 16. The adapter 15 is disposed on the housing 11 and is configured to connect to or disconnect from an external device. The actuator 16 is configured to drive the adapter 15 to connect to or disconnect from the external device in response to a manual force or under control of a computer program, and the actuator 16 is disposed on the housing 11.

In some embodiments, the adapter 15 is movably disposed on the housing 11, and the execution unit 3 is connected to the robot body 2 through the adapter 15. The adapter 15 has a locked position and an unlocked position during motion. The adapter 15 is configured to be locked with the external device when in the locked position and to be separated from the external device when in the unlocked position. In some embodiments, the external device is the body 20.

Specifically, as shown in FIG. 23 and FIG. 24, the adapter 15 is in the locked position. As shown in FIG. 23 and FIG. 26, the adapter 15 rotates from the locked position to the unlocked position.

To unlock the robot body 2 and the execution unit 3, an external force is applied to the actuator 16 to quickly unlock the robot body 2 and the execution unit 3. The unlocking process is simple and time-efficient.

As shown in FIG. 19, in some embodiments, the actuator 16 is disposed at a top portion 118 of the housing, or the actuator 16 is disposed adjacent to the top portion 118 of the housing. This arrangement enables the user to quickly locate the actuator 16 and apply an external force to it, so as to quickly unlock the execution unit 3 and the external device, reducing the time spent searching for the actuator 16.

As shown in FIG. 19, FIG. 20, FIG. 21, and FIG. 22, in some embodiments, the housing 11 defines a receiving opening 14, and at least a portion of the actuator 16 is received within the receiving opening 14 and exposed through the receiving opening 14. This arrangement reduces the time spent searching for the actuator 16.

As shown in FIG. 19, FIG. 20, FIG. 22, FIG. 23, and FIG. 24, in some embodiments, the housing 11 defines an interior cavity 111. The housing 11 has a first surface 113 and a second surface 114 adjacent to each other, and the receiving opening 14 spans the first surface 113 and the second surface 114 of the housing and is in communication with the interior cavity 111.

The actuator 16 has a transmission portion 162 and an operating portion 161 connected to each other. The transmission portion 162 is disposed within the interior cavity 111, and the operating portion 161 is received within the receiving opening 14 and forms a flush surface with at least one of the first surface 113 and the second surface 114 of the housing. This arrangement enables the operating portion 161 of the actuator 16 to form a flush surface with at least one surface 112 of the housing. Compared to an arrangement where the operating portion 161 protrudes from the surface 112 of the housing, this arrangement facilitates mounting of the actuator 16, reduces the likelihood of the actuator 16 being damaged by external forces, extends the service life of the actuator 16, and improves the overall appearance.

In some embodiments, the operating portion 161 forms a flush surface with each of the first surface 113 and the second surface 114 of the housing.

As shown in FIG. 20, in some embodiments, the operating portion 161 forms a flush surface with the first surface 113 of the housing, and the operating portion 161 protrudes beyond the second surface 114 of the housing. This arrangement increases friction when the user actuates the operating portion 161, making it easy for the user to actuate the operating portion 161, improving tactile feedback, and enhancing the user experience.

As shown in FIG. 20 and FIG. 29, in some embodiments, the operating portion 161 has a fixed part 1311 and a free part 1312. The fixed part 1311 is disposed on the housing 11, and the free part 1312 is rotatable relative to the housing 11 via the fixed part 1311. The fixed part 1311 forms a flush surface with the first surface 113 of the housing, the free part 1312 forms a flush surface with the first surface 113 of the housing, and the free part 1312 protrudes beyond the second surface 114 of the housing. This arrangement has a simple structure. The user can actuate the free part 1312, causing the free part 1312 to rotate relative to the housing 11 and drive the adapter 15 to rotate. The overall structure of the execution unit 3 is aesthetically pleasing, and the likelihood of the actuator 16 being damaged by external forces due to protrusion from the housing surface 112 is reduced, thereby extending the service life of the actuator 16.

As shown in FIG. 20 and FIG. 29, in some embodiments, at least a portion of a projection of the free part 1312 onto the first surface 113 of the housing is arcuate, and the arcuate portion of the free part 1312 protrudes beyond the second surface 114 of the housing. This arrangement increases friction when the user actuates the operating portion 161, making it easy for the user to actuate the operating portion 161, improving tactile feedback, and enhancing the user experience.

As shown in FIG. 22, in some embodiments, a projection of the receiving opening 14 onto the first surface 113 of the housing is elongated. This arrangement increases the torque of the operating portion 161, facilitating actuation of the operating portion 161.

As shown in FIG. 21, FIG. 27, and FIG. 28, in some embodiments, the housing 11 includes a first sub-housing 115 and a second sub-housing 116 connected to each other. The first sub-housing 115 defines a first notch 1151 and a second notch 1152. The first notch 1151 and the second notch 1152 are disposed on two adjacent surfaces 112 of the first sub-housing and are in communication with each other. The second sub-housing 116 is snap-fitted to the first sub-housing 115 such that the first notch 1151 and the second notch 1152 together form the receiving opening 14. This arrangement simplifies the production process of the receiving opening 14 and facilitates assembly of the actuator 16 on the first sub-housing 115.

As shown in FIG. 21, in some embodiments, a connecting member 117 is disposed between the first sub-housing 115 and the second sub-housing 116, and the first sub-housing 115 and the second sub-housing 116 are detachably connected through the connecting member 117. This arrangement facilitates mounting and disassembly of the housing 11, and facilitates subsequent inspection and maintenance of internal components of the housing 11.

Referring to FIG. 30, FIG. 31, and FIG. 32, in some embodiments, a multifunctional robot 3000 is provided. The multifunctional robot 3000 includes a functional unit 600 and a travel unit 500. The multifunctional robot 3000 is the robot 2000 provided in any of the above embodiments. The functional unit 600 is at least a part of the head 10, and the travel unit 500 is at least a part of the body 20.

The functional unit 600 and the travel unit 500 are connected through a connection assembly along a length direction of the multifunctional robot 3000 or a movement direction of the travel unit 500. FIG. 30 shows the functional unit 600 and the travel unit 500 in a disassembled state. When assembling the two, the relative positions of the functional unit 600 and the travel unit 500 are adjusted accordingly.

The functional unit 600 is provided with a working mechanism for performing operations. The working mechanism is capable of performing functions including but not limited to snow clearing, and/or weed removal, and/or seeding, and/or surface cleaning. The travel unit 500 is capable of traveling independently of the functional unit 600 under control of a user and/or a computer program. The travel unit 500 may be provided with a crawler belt and a power module configured to drive the crawler belt, and the power module drives the crawler belt to move, thereby enabling the travel unit 500 to move along its own length direction. The length direction of the travel unit 500 is the same as the length direction of the multifunctional robot 3000. In FIG. 30, the length direction of the travel unit 500 is parallel to the direction indicated by the arrow.

In some embodiments, the functional unit 600 and the travel unit 500 are detachably connected, thereby facilitating maintenance of the functional unit 600 and/or the travel unit 500 and replacement of functional units with different working mechanisms. In addition, since the functional unit 600 and the travel unit 500 are detachably connected, the same travel unit 500 may be used with functional units 600 having different working mechanisms, making the multifunctional robot 3000 suitable for different operating scenarios.

In some embodiments, the connection assembly includes a first connection portion 310 and a second connection portion 320. The first connection portion 310 and the second connection portion 320 are detachably connected, the first connection portion 310 is at least a part of the first connecting component 100, and the second connection portion 320 is at least a part of the second connecting component 200. The travel unit 500 has a first connection portion 310, the functional unit 600 has a second connection portion 320, and the travel unit 500 and the functional unit 600 are manually connectable and disconnectable through the first connection portion 310 and the second connection portion 320. The manual connection and disconnection simultaneously satisfies the following conditions:

The user does not use any additional tools and is able to complete the manual connection and disconnection using only their own limbs; the manual connection and disconnection are completable without operating the travel unit 500 or changing an orientation of the travel unit 500; during manual connection and disconnection, the functional unit 600 moves relative to the travel unit 500 in a single direction; and no mechanical transmission exists between the functional unit 600 and the travel unit 500 during and/or after manual connection.

Before assembly, the functional unit 600 and the travel unit 500 are in a separated state. When assembling, the positions of the functional unit 600 and/or the travel unit 500 are adjusted in advance so that the first connection portion 310 and the second connection portion 320 are aligned with each other. The functional unit 600 or the travel unit 500 is driven to move along the length direction of the multifunctional robot 3000 so that the first connection portion 310 and the second connection portion 320 approach each other. Since the travel unit 500 is provided with a power module, the travel unit 500 moves toward the functional unit 600 along its own length direction by activating the power module. As the first connection portion 310 and the second connection portion 320 continuously approach each other and engage, the connection between the functional unit 600 and the travel unit 500 is achieved.

As shown by the above process, the connection between the functional unit 600 and the travel unit 500 is achieved without external tools during assembly, making the operation simple, convenient, and efficient.

As shown in FIG. 32 to FIG. 35, in some embodiments, the travel unit 500 includes a position adjustment device 400, and the first connection portion 310 is disposed on the position adjustment device 400. The position adjustment device 400 is configured to adjust a pitch angle and/or a ground clearance of the functional unit 600.

As shown in FIG. 31, FIG. 36, and FIG. 36a, the functional unit 600 includes an assembly component 410, the second connection portion 320 is disposed on the assembly component 410, and the assembly component 410 is a backplate 17.

As shown in FIG. 34a, the first connection portion 310 includes an insertion column 430, the insertion column 430 is an insertion rod 110, and the insertion column 430 has a latch slot 311 corresponding to the latch slot 1201.

As shown in FIG. 36a, the functional unit 600 includes a body having an insertion hole 210, and the body is at least a part of the head 10. The second connection portion 320 includes a latch 2201 disposed within the body, and the latch 2201 is disposed adjacent to the outlet end of the insertion hole 210. The insertion column 430 is configured to be inserted into the insertion hole 210 to engage the latch slot 311, thereby achieving latching engagement between the latch 2201 and the latch slot 311. The wall of the insertion hole 210 guides and positions the insertion column 430. The insertion hole 210 is disposed on the assembly component 410, and the latch 2201 is rotatably connected to the functional unit 600.

In some embodiments, the latch 2201 is rotatably disposed on the body and has a locked position in which the latch 2201 engages the insertion column 430 and an unlocked position in which the latch 2201 is separated from the insertion column 430. The body may be provided with a manual portion, the manual portion being drivingly connected to the latch 2201 through a corresponding link mechanism. The user manually drives the manual portion to rotate the latch 2201 to the unlocked position. At this time, the insertion column 430 is fully inserted into the insertion hole 210, and the manual portion is then released. Under the force of an elastic member such as a tension spring, the latch 2201 automatically rotates to the locked position, thereby completing the latching engagement between the latch 2201 and the latch slot 311. To disengage, the user manually drives the manual portion to rotate the latch 2201 to the unlocked position, allowing the latch 2201 to clear the insertion column 430, after which the insertion column 430 is moved out.

To enhance stability and reliability of the connection, a plurality of first connection portions 310 and a corresponding plurality of second connection portions 320 are provided, each first connection portion 310 corresponding to one second connection portion 320.

Before assembling the functional unit 600 and the travel unit 500, the position of the insertion column 430 is adjusted in advance through the position adjustment device 400 so that the insertion column 430 is parallel to or aligned with the length direction of the travel unit 500.

When assembling the functional unit 600 and the travel unit 500, the insertion column 430 is first aligned with the corresponding insertion hole 210. By moving the travel unit 500, the insertion column 430 is inserted into the insertion hole 210 through the inlet end of the insertion hole 210. As the travel unit 500 continues to move forward or backward, the insertion column 430 moves toward the outlet end of the insertion hole 210. When the tip of the insertion column 430 extends beyond the outlet end of the insertion hole 210 and makes contact with the latch 2201, the travel unit 500 continues to move a further distance. The latch 2201 is then rotated to the locked position, and the latch 2201 engages the latch slot 311 on the insertion column 430. At this time, the connection between the first connection portion 310 and the second connection portion 320 is completed, and correspondingly, the assembly of the functional unit 600 and the travel unit 500 is completed. The latch 2201 may be connected to an elastic member such as a tension spring, thereby maintaining the latching engagement between the latch 2201 and the latch slot 311. The latch 2201 and the latch slot 311 can be disengaged by rotating the latch 2201 with an external force.

To enable the functional unit 600 to move independently to cross obstacles, in some embodiments, the position adjustment device 400 is disposed on the travel unit 500, and the position adjustment device 400 acts on the functional unit 600 through the connection assembly, thereby adjusting the pitch angle and/or ground clearance of the functional unit 600 and adjusting the position of the functional unit 600.

After the position adjustment device 400 is activated, the insertion column 430 directly acts on the insertion hole 210 and applies a force to an inner wall of the insertion hole 210. The force is transmitted to the functional unit 600 through the insertion hole 210, thereby adjusting the pitch angle and/or ground clearance of the functional unit 600, and changing the position of the functional unit 600 to enable the functional unit 600 to cross obstacles.

In some embodiments, the position adjustment device 400 includes a first drive module 411 and a crank-rocker mechanism 401. The first drive module 411 is drivingly connected to the crank-rocker mechanism 401 to drive the crank-rocker mechanism 401 to move, and the crank-rocker mechanism 401 is configured to drive the functional unit 600 to move when actuated, so as to adjust a pitch angle and/or a ground clearance of the first connection portion 310. The first connection portion 310 is disposed on the crank-rocker mechanism 401.

As shown in FIG. 35, the crank-rocker mechanism 401 includes a crank 412, a rocker 413, and a coupler link 414. Upper ends of the crank 412 and the rocker 413 are pivotally connected to respective ends of the coupler link 414, and lower ends of the crank 412 and the rocker 413 are each pivotally connected to the travel unit 500. The first connection portion 310 is mounted on the rocker 413.

The first drive module 411 is drivingly connected to the crank 412, and the functional unit 600 is mounted on the rocker 413 through the connection assembly. After the first drive module 411 is activated, the rocker 413 swings, driving the functional unit 600 to move, thereby adjusting the pitch angle of the functional unit 600.

The first drive module 411 includes a drive output portion 4111 configured to output linear motion, and the drive output portion 4111 is pivotally connected to an upper end of the crank 412.

As shown in FIG. 34b, a pivot connection portion 4112 is disposed on the first drive module 411, and the first drive module 411 is pivotally connected to the travel unit 500 through the pivot connection portion 4112.

The pivot connection portion 4112 includes a first pivot member 415 and a second pivot member 416. The first pivot member 415 is disposed at a tail end of the first drive module 411, and the second pivot member 416 may be fixed to the travel unit 500 by a screw connection or other means. A rotating shaft 417 passes through the first pivot member 415 and the second pivot member 416, thereby achieving the pivot connection between the first pivot member 415 and the second pivot member 416.

Since the first pivot member 415 is fixed on the first drive module 411 and the second pivot member 416 is fixed on the travel unit 500, the first drive module 411 achieves a pivot connection with the travel unit 500 through the engagement of the first pivot member 415 and the second pivot member 416.

In some embodiments, the first drive module 411 includes one of an electric push rod, a linear motor, a hydraulic cylinder, or a pneumatic cylinder. For an electric push rod, the drive output portion 4111 is the push rod. For a linear motor, the drive output portion 4111 is the output shaft. For a hydraulic cylinder or a pneumatic cylinder, the drive output portion 4111 is the piston.

In addition, the first drive module 411 may also use other devices or mechanisms capable of achieving linear motion.

To enable the multifunctional robot 3000 to quickly and reliably cross obstacles during travel, the multifunctional robot 3000 may be configured as follows.

In some embodiments, the multifunctional robot 3000 further includes: a detection device configured to detect a ground clearance of the functional unit 600; and/or a recognition device configured to recognize obstacles in front of the functional unit 600; and a controller electrically connected to the recognition device and configured to control operation of the position adjustment device 400 based on recognition information from the recognition device.

After the recognition device recognizes an obstacle, the controller sends a control signal to the position adjustment device 400. The position adjustment device 400 drives the functional unit 600 to move so that the functional unit 600 is raised. When the detection device detects that the functional unit 600 has been raised to a preset height, the position adjustment device 400 stops operating. The detection device may be a Hall sensor or similar device. The recognition device may include a camera or similar device.

The detection device may be selected based on the first drive module 411. For example, when the first drive module 411 uses an electric push rod, the Hall sensor detects the motor of the electric push rod. Based on the number of rotations of the output shaft of the motor, the extension and retraction length of the electric push rod can be determined, and the swing angle of the rocker 413 can be determined accordingly. Since the functional unit 600 is mounted on the rocker 413 through the connection assembly, the rotation angle of the rocker 413 corresponds to the pitch angle of the functional unit 600. By controlling the rotation angle of the rocker 413, the pitch angle of the functional unit 600 can be controlled, thereby adjusting the position of the functional unit 600.

In some embodiments, the multifunctional robot 3000 further includes a storage module. The storage module stores an image library containing images of obstacles of different shapes and types. Each image in the image library is associated with a lifting height at which the functional unit 600 is raised to cross the obstacle shown in the image.

When the multifunctional robot 3000 encounters an obstacle during travel, the multifunctional robot 3000 stops, and the recognition device starts and captures images of the obstacle. The captured images are analyzed and compared with the images in the image library. If an image in the image library completely matches the outline of the obstacle, the obstacle is determined to have been recognized. The lifting height associated with the image is obtained and set as the preset height for crossing the obstacle. The position adjustment device 400 drives the functional unit 600 to move so that the functional unit 600 is raised to the preset height, and the multifunctional robot 3000 continues to travel, thereby crossing the obstacle.

If no image completely matching the outline of the obstacle is found in the image library, the image closest to the outline of the obstacle in the image library is set as a target image. The lifting height associated with the target image is obtained and set as a pre-adjustment height. The position adjustment device 400 drives the functional unit 600 to move so that the functional unit 600 is raised to the pre-adjustment height. The multifunctional robot 3000 then continues to travel:

S1: if the multifunctional robot 3000 passes the obstacle, obstacle crossing is successful. S2: if the multifunctional robot 3000 fails to pass the obstacle, the position adjustment device 400 controls the functional unit 600 to continue rising by the set height from the current lifting height, and then controls the multifunctional robot 3000 to travel. S3: if the multifunctional robot 3000 still fails to pass the obstacle, step S2 is repeated until obstacle crossing is successful. The set height may be configured as appropriate, for example, 1 cm or 2 cm.

As shown in FIG. 37, the position adjustment device 400 includes a second drive module 421 and a guide-rail mechanism 420. The second drive module 421 drives the guide-rail mechanism 420 to move, and the guide-rail mechanism 420 is configured to adjust a pitch angle and/or a ground clearance of the functional unit 600, thereby adjusting the position of the functional unit 600. The first connection portion 310 is disposed on the guide-rail mechanism 420.

In some embodiments, the guide-rail mechanism 420 includes a slider 422, a linear guide rail 423, a transmission member 424, and a swing member 425. The slider 422 is slidably disposed on the linear guide rail 423. The linear guide rail 423 is fixed to the travel unit 500 and disposed horizontally.

A first end of the transmission member 424 is pivotally connected to the slider 422, and a second end of the transmission member 424 is pivotally connected to an upper end of the swing member 425. A lower end of the swing member 425 is pivotally connected to the travel unit 500. Since the linear guide rail 423 is fixed to the travel unit 500, the lower end of the swing member 425 may also be pivotally disposed on the linear guide rail 423.

The second drive module 421 is drivingly connected to the slider 422, and the functional unit 600 is mounted on the swing member 425 through the connection assembly. After the second drive module 421 is activated, the swing member 425 swings, driving the functional unit 600 to move, thereby adjusting the pitch angle and/or ground clearance of the functional unit 600 and changing the position of the functional unit 600. As shown in FIG. 37, the first connection portion 310 is disposed on the swing member 425.

The second drive module 421 includes a motion output portion 4211 configured to output linear motion. The motion output portion 4211 is fixedly connected to the slider 422 and disposed parallel to the linear guide rail 423.

In some embodiments, the second drive module 421 includes one of an electric push rod, a linear motor, a hydraulic cylinder, or a pneumatic cylinder. For an electric push rod, the motion output portion 4211 is the push rod. For a linear motor, the motion output portion 4211 is the output shaft. For a hydraulic cylinder or a pneumatic cylinder, the motion output portion 4211 is the piston.

In addition, the second drive module 421 may also use other devices or mechanisms capable of achieving linear motion.

In some embodiments, the position adjustment device 400 is configured to adjust the ground clearance of the functional unit 600.

As shown in FIG. 38, the position adjustment device 400 includes a third drive module 431 and a mounting member 432. The third drive module 431 drives the mounting member 432 to raise and lower, and the mounting member 432 drives the functional unit 600 to move, thereby changing the ground clearance of the functional unit 600.

The first connection portion 310 is disposed on the mounting member 432, and the third drive module 431 is drivingly connected to the mounting member 432 to raise and lower the mounting member 432. After the third drive module 431 is activated, the third drive module 431 drives the mounting member 432 to raise and lower. Since the functional unit 600 is mounted on the mounting member 432 through the connection assembly, as the height position of the mounting member 432 changes, the ground clearance of the functional unit 600 also changes accordingly, thereby adjusting the ground clearance of the functional unit 600.

The third drive module 431 includes a linear lifting mechanism. The linear lifting mechanism may be a worm gear lifting mechanism, a lead screw lifting mechanism, or similar. The third drive module 431 is described below using a lead screw nut lifting mechanism as an example.

Referring to FIG. 38, the third drive module 431 includes a nut 433 and a lead screw 434. The nut 433 is fixedly connected to the mounting member 432, the nut 433 is also in threaded connection with the lead screw 434, and the nut 433 is also slidably connected to a vertically disposed linear slide rail 435.

The lead screw 434 is vertically disposed, and opposite ends of the lead screw 434 may be rotatably connected to the travel unit 500 through bearings. The lead screw 434 may be drivingly connected to a drive motor through gear transmission, and the drive motor drives the lead screw 434 to rotate.

After the drive motor is started, the lead screw 434 rotates, and under the effect of the thread engagement and the linear slide rail 435, the nut 433 moves in a vertical direction, thereby raising and lowering the mounting member 432. As the height position of the mounting member 432 changes, the ground clearance of the functional unit 600 also changes through the connection assembly, thereby adjusting the ground clearance of the functional unit 600.

In the embodiments of the present disclosure, unless otherwise expressly specified or limited, the terms “mounting,” “connecting,” and similar terms are to be broadly construed. For example, the connection may be a fixed connection, a detachable connection, an integral connection, or a driving connection; or the connection may be a direct connection or an indirect connection through an intermediate medium. A person of ordinary skill in the art may understand the specific meanings of the above terms in the present disclosure based on the specific context.

In addition, the terms “first,” “second,” and similar terms are used only for descriptive purposes and are not to be construed as indicating or implying any specific or special structure. A description using the term “some embodiments” means that the specific features, structures, materials, or characteristics described in connection with the embodiment or example are included in at least one embodiment or example of the present disclosure. In the present disclosure, the illustrative use of these terms does not necessarily refer to the same embodiment or example. Moreover, the described specific features, structures, materials, or characteristics may be combined in any suitable manner in one or more embodiments or examples. In addition, those skilled in the art may combine the different embodiments or examples described in the present disclosure, as well as the features of different embodiments or examples, provided they are not mutually contradictory.

The above embodiments are provided only to illustrate the technical solutions of the present disclosure and not to limit them. Although the present disclosure has been described in detail with reference to the foregoing embodiments, those of ordinary skill in the art will understand that the technical solutions described in the foregoing embodiments may be modified, or some of the technical features therein may be equivalently substituted. Such modifications or substitutions do not cause the corresponding technical solutions to depart from the spirit and scope of the technical solutions of the embodiments of the present disclosure, and shall fall within the scope of the present disclosure.

1-47. (canceled)

48. A robot, comprising:
a head;
a body; and
a connection structure, wherein the connection structure comprises a first connecting component and a second connecting component, the first connecting component being disposed on one of the head or the body, and the second connecting component being disposed on the other of the head or the body, the first connecting component and the second connecting component being detachably connectable; and the head and the body being detachably connected through the first connecting component and the second connecting component.

49. The robot according to claim 48, wherein:
the first connecting component comprises an insertion rod having a first engaging portion;
the second connecting component comprises a guide portion having an insertion hole and a second engaging portion; and
the insertion rod is configured to be inserted into the insertion hole such that the second engaging portion engages the first engaging portion.

50. The robot according to claim 49, wherein:
the first engaging portion comprises a latch slot disposed on the insertion rod;
the second engaging portion comprises a rotatable latch disposed adjacent to an outlet end of the insertion hole and configured to engage the latch slot; and
a length of the insertion rod is greater than a depth of the insertion hole.

51. The robot according to claim 49, wherein:
the first engaging portion comprises a groove disposed on the insertion rod, the groove being an annular groove extending circumferentially around the insertion rod; and
the second engaging portion comprises a slidable protrusion disposed within the insertion hole and configured to be received within the groove.

52. The robot according to claim 49, wherein:
the first engaging portion comprises a latch slot disposed on the insertion rod;
the second engaging portion comprises a rotatable latch configured to engage the latch slot;
a first one of the head or the body comprises a housing and at least one locking-hook assembly;
the locking-hook assembly comprises a locking hook rotatably disposed on the housing, the locking hook forming at least a portion of the latch of the second engaging portion, the locking-hook assembly being configured such that the locking hook is rotatable under an external force; and
the locking hook has a locked position in which the locking hook is connected to a second one of the head or the body, and an unlocked position in which the locking hook is separated from the other of the head or the body.

53. The robot according to claim 52, wherein:
the locking-hook assembly comprises a transmission member movably disposed on the housing;
the transmission member is drivingly connected to the locking hook through a link member so as to drive the locking hook to rotate under the external force;
the housing defines an interior cavity and comprises a partition;
the locking hook is disposed on an inner side of the partition within the interior cavity;
the transmission member is disposed on an outer side of the partition opposite the inner side; and
the link member is movably disposed on the partition.

54. The robot according to claim 53, wherein:
the locking-hook assembly comprises a toggle member having an operating end and a connecting end, the operating end being exposed from the housing, the connecting end being drivingly connected to an end of the transmission member; and
the toggle member is configured to drive the transmission member to move under the external force so as to drive the locking hook to rotate.

55. The robot according to claim 52, wherein:
one of the housing or the locking hook defines a limit slot extending in a rotational direction of the locking hook; and
the other of the housing or the locking hook includes a limit member slidably received in the limit slot along a length direction of the limit slot.

56. The robot according to claim 48, wherein the head comprises an execution unit, the execution unit comprising:
a working component configured to perform at least one of snow clearing, weed removal, seeding, or surface cleaning;
a housing;
an adapter disposed on the housing; and
an actuator disposed on the housing and configured to drive the adapter to connect the execution unit to or disconnect the execution unit from the body in response to a manual force or under control of a computer program.

57. The robot according to claim 56, wherein:
the actuator has a transmission portion and an operating portion connected to each other;
the operating portion has a fixed part and a free part;
the fixed part is disposed on the housing; and
the free part is rotatable relative to the housing via the fixed part and configured to drive the adapter upon actuation.

58. The robot according to claim 48, wherein:
the body includes a position adjustment device;
the first connecting component is disposed on the position adjustment device; and
the position adjustment device is configured to move the first connecting component, thereby adjusting a pitch angle and/or a ground clearance of the head.

59. The robot according to claim 58, wherein:
the position adjustment device comprises a first drive module and a crank-rocker mechanism;
the first drive module is drivingly connected to the crank-rocker mechanism; and
the crank-rocker mechanism is configured to drive the head to move so as to adjust the pitch angle and/or the ground clearance of the head.

60. The robot according to claim 59, wherein:
the crank-rocker mechanism comprises a crank, a rocker, and a coupler link;
first ends of the crank and the rocker are rotatably connected to respective ends of the coupler link;
second ends of the crank and the rocker are each rotatably connected to the body; and
the first connecting component is mounted on the rocker.

61. The robot according to claim 60, wherein the first drive module comprises a drive output portion configured to output linear motion, the drive output portion being pivotally connected to an end of the crank.

62. The robot according to claim 61, wherein the first drive module comprises a pivot connection portion, the first drive module being pivotally connected to the body through the pivot connection portion.

63. The robot according to claim 58, wherein:
the position adjustment device comprises a second drive module and a guide-rail mechanism;
the second drive module is drivingly connected to the guide-rail mechanism; and
the guide-rail mechanism is configured to adjust the pitch angle and/or the ground clearance of the head.

64. The robot according to claim 63, wherein:
the guide-rail mechanism comprises a slider, a linear guide rail, a transmission member, and a swing member;
the slider is slidably disposed on the linear guide rail and drivingly connected to the second drive module;
the transmission member has a first end rotatably connected to the swing member and a second end rotatably connected to the slider;
a second end of the swing member is rotatably connected to the body; and
the first connecting component is mounted on the swing member such that when the swing member swings, the first connecting component moves therewith.

65. The robot according to claim 58, wherein:
the position adjustment device comprises a third drive module and a mounting member;
the first connecting component is disposed on the mounting member;
the third drive module comprises a linear lifting mechanism drivingly connected to the mounting member; and
the linear lifting mechanism is configured to raise and lower the mounting member and the first connecting component therewith, thereby adjusting the ground clearance of the head.

66. The robot according to claim 58, comprising:
a recognition device configured to recognize an obstacle in front of the head; and
a controller electrically connected to the recognition device and configured to control operation of the position adjustment device based on recognition information from the recognition device.

67. The robot according to claim 48, wherein during connection and disconnection of the head and the body, the head moves relative to the body in a single direction.
